(19) United States
(12) Patent Application Publication
(10) Pub. No.: US 2024/0193438 A1
(43) Pub. Date: Jun. 13, 2024

(54) DOMAIN KNOWLEDGE-BASED EVALUATION OF MACHINE LEARNING MODELS

(71) Applicant: International Business Machines Corporation, Armonk, NY (US)

(72) Inventors: ANNA PAOLA CARRIERI, Manchester (GB); LAURA-JAYNE GARDINER, Wirral (GB)

(21) Appl. No.: 18/065,296

(22) Filed: Dec. 13, 2022

(51) Int. Cl. G06N 5/022

(52) U.S. Cl. CPC G06N 5/022

(57) ABSTRACT

A method, computer program product, and computer system are provided for domain knowledge-based evaluation of machine learning models for a target subject. The method accesses a model explanation of each of a plurality of machine learning models for a target subject, where a model explanation includes a set of identified important features. The method receives a domain expert input including a set of known important features for the target subject. The method compares the domain expert input with the plurality of model explanations to evaluate consensus based on at least some of the known important features concurring with at least some of the identified important features of the model explanations and outputs a score of the machine learning models with the score including the evaluated consensus.

### BACKGROUND

The present invention relates to domain knowledge-based evaluation of machine learning models, and more specifically, to analyzing machine learning models with respect to domain expert input.

In the life sciences domain, supervised machine learning (ML) models can be trained using a large range of experimental and informational datasets to predict impactful targets. For example, in healthcare, researchers have shown that it is possible to predict a patient's pharmacological response to drug treatment from features including their demographic information, medical history, genomic and transcriptomic information. Such applications form the basis of personalized medicine allowing medical decisions and interventions to be tailored to each patient based on their predicted response or risk of disease.

The development of a classification or regression predictive ML model using experimental datasets is challenging, since the data can be inherently heterogenous, noisy and inconsistent. This effect is exacerbated when omic technologies are used. Omics aim at the collective characterization and quantification of pools of biological molecules that translate into the structure, function, and dynamics of an organism or organisms. In omic technologies, the extracted feature sets can also be large (in the order of hundreds of thousands of features) resulting in highly dimensional datasets. An extreme example of this would be developing a ML model that uses a combination of features from multiple omic datasets and clinical data combined to predict patient response to treatment.

Often it is not possible to know beforehand which ML algorithm (e.g., Random Forest, Decision-tree-based, Neural Network, etc.) will perform best for a particular prediction task with a given feature set, as it is generally unknowable. A widely used strategy is to tune, fit and evaluate a suite of different ML algorithms on a given dataset. As such, a major challenge from applied ML then becomes how to choose between the different methods that were tuned and tested for a given problem (i.e., ML model selection). The simplest solution could be to choose the ML algorithm that provides the best predictive performance on unseen data points in the test set. However, accuracy of the ML algorithms is not the only factor to consider when choosing the best one. For example, the test set is generally a subset of the original dataset and the most accurate algorithm on the test set might not work as well on a completely independent unseen dataset (a holdout dataset). Selection of the ‘best’ predictive ML methods for a task can be subjective and dependent on multiple factors each with different user-specific prioritizations including time to train, ease of explanation and interpretability, complexity, accuracy, robustness, and generalizability.

### SUMMARY

According to an embodiment of the present disclosure, there is provided a computer-implemented method for domain knowledge-based evaluation of machine learning models for a target subject, said computer-implemented method comprising: accessing a model explanation of each of a plurality of machine learning models for a target subject, wherein a model explanation includes a set of identified important features; receiving a domain expert input including a set of known important features for the target subject; comparing the domain expert input with the plurality of model explanations to evaluate consensus based on at least some of the known important features concurring with at least some of the identified important features of the model explanations; and scoring the machine learning models based on the evaluated consensus.

According to another embodiment of the present disclosure, there is provided a system for analyzing machine learning models for domain knowledge-based evaluation of machine learning models for a target subject, comprising: a processor and a memory configured to provide computer program instructions to the processor to execute the function of code modules, the program instructions comprising: accessing a model explanation of each of a plurality of machine learning models for a target subject, wherein a model explanation includes a set of identified important features; receiving a domain expert input including a set of known important features for the target subject; comparing the domain expert input with the plurality of model explanations to evaluate consensus based on at least some of the known important features concurring with at least some of the identified important features of the model explanations; and scoring the machine learning models based on the evaluated consensus.

According to a further embodiment of the present invention there is provided a computer program product for domain knowledge-based evaluation of machine learning models for a target subject, the computer program product comprising a computer readable storage medium having program instructions embodied therewith, the program instructions executable by a processor to cause the processor to: access a model explanation of each of a plurality of machine learning models for a target subject, wherein a model explanation includes a set of identified important features; receive a domain expert input including a set of known important features for the target subject; compare the domain expert input with the plurality of model explanations to evaluate consensus based on at least some of the known important features concurring with at least some of the identified important features of the model explanations; and score the machine learning models based on the evaluated consensus.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram of an illustrating an embodiment of a computing environment and components thereof, upon which execution of computer code and embodiments described herein may be implemented in accordance with the present disclosure.

FIG. 2 depicts a block diagram of illustrating an embodiment of a method for domain knowledge-based evaluation of machine learning models for a target subject, in the context of system components, in accordance with the present disclosure.

FIG. 3 depicts a flow diagram illustrating an embodiment of a method domain knowledge-based evaluation of machine learning models for a target subject, in accordance with the embodiments of the present disclosure.

FIG. 4 depicts block diagram illustrating an embodiment of a portion of a system capable of domain knowledge-based evaluation of machine learning models for a target subject, in accordance with embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for domain knowledge-based evaluation of machine learning (ML) models for a target subject. Analysis of the ML models provides a domain knowledge-driven predictive ML algorithm selection strategy.

Domain knowledge may be incorporated into the ML algorithm selection strategy via an automated evaluation of the validity or significance of ML model explanations using known ground truths and insights alongside standard metrics such as accuracy, training time, generalizability, etc.

Model explanation of each of a plurality of generated ML models for a target subject are accessed to evaluate and compare the ML models. The model explanations include a set of identified important features and an associated effect on the target subject. A domain expert input is used, including a set of known important features for the target subject, with an effect of the features on the target subject. The domain expert input may be a direct input into a user interface or may be an automated extraction from a linked domain expert resource.

The ML model explanations are compared with the domain expert input to evaluate consensus between each of the ML model explanations and the domain expert input. The most influential features from the ML model explanations may automatically be compared to domain expert inputs to identify if associations are already known between them and the target for prediction. This can be used as an additional criterion for the selection of the best ML algorithm. A score or ranking of the ML models is output, including the evaluated consensus.

The analysis of ML models to select a best model for a target subject may be used in a wide range of technical implementations, in particular, automated medical treatment and pharmacological response analysis.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

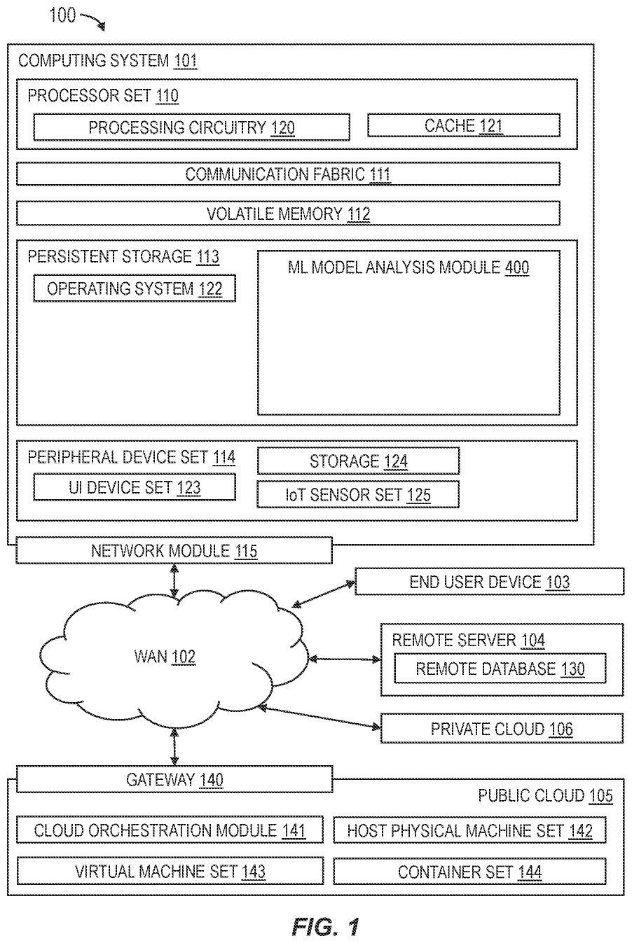

Referring to FIG. 1, computing environment 100 contains an example of an environment for the execution of at least some of the computer code involved in performing the inventive methods, such as a ML model analysis module 400. In addition to block 400, computing environment 100 includes, for example, computing system 101, wide area network (WAN) 102, end user device (EUD) 103, remote server 104, public cloud 105, and private cloud 106. In this embodiment, computing system 101 includes processor set 110 (including processing circuitry 120 and cache 121), communication fabric 111, volatile memory 112, persistent storage 113 (including operating system 122 and block 400, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTING SYSTEM 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computing system 101, to keep the presentation as simple as possible. Computing system 101 may be located in a cloud, even though it is not shown in a cloud in FIG. 1. On the other hand, computing system 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computing system 101 to cause a series of operational steps to be performed by processor set 110 of computing system 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 400 in persistent storage 113.

COMMUNICATION FABRIC 111 is the signal conduction path that allows the various components of computing system 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computing system 101, the volatile memory 112 is located in a single package and is internal to computing system 101, but, alternatively or additionally, the volatile memory may be distributed over multiple packages and/or located externally with respect to computing system 101.

PERSISTENT STORAGE 113 is any form of non-volatile storage for computers that is now known or to be developed in the future. The non-volatility of this storage means that the stored data is maintained regardless of whether power is being supplied to computing system 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 400 typically includes at least some of the computer code involved in performing the inventive methods.

PERIPHERAL DEVICE SET 114 includes the set of peripheral devices of computing system 101. Data communication connections between the peripheral devices and the other components of computing system 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computing system 101 is required to have a large amount of storage (for example, where computing system 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computing system 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computing system 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computing system 101) and may take any of the forms discussed above in connection with computing system 101. EUD 103 typically receives helpful and useful data from the operations of computing system 101. For example, in a hypothetical case where computing system 101 is designed to provide a recommendation to an end user, this recommendation would typically be communicated from network module 115 of computing system 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, then this historical data may be provided to computing system 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

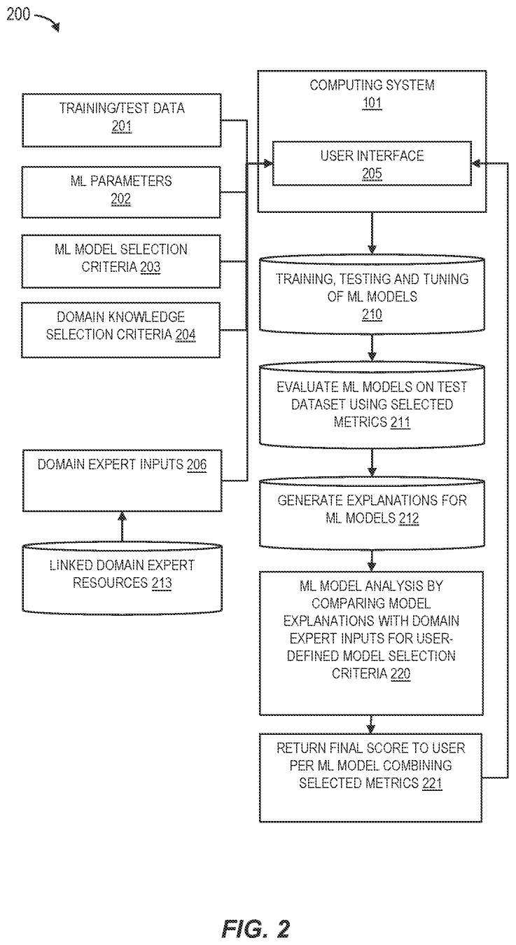

FIG. 2 shows a schematic diagram illustrating an example embodiment of a workflow 200 for analyzing ML models to provide a domain knowledge-driven predictive ML algorithm selection strategy for a target issue.

The workflow 200 shows a computing system 101, which may be of the form as shown and described in relation to FIG. 1, with a user interface 205 for receiving user inputs and displaying outputs.

The workflow 200 accepts in input from a user including training and test datasets 201 and a set of ML parameters 202 (for example, in the form of a configuration file) which allow the user to choose which ML algorithms to run, what type of hyper parameter optimization (HPO) to perform, etc.

The workflow 200 also accepts ML model selection criteria 203 in the form of a set of metrics that will be used to compare the predictive ML models and choose the best one(s). These set of metrics include an explainability score and the score may be weighted for its overall input to the ML model selection. The workflow 200 may also accept domain knowledge selection criteria 204 to define the domain-expert inputs and resources to be used.

Training, testing, and hyper-tuning of a range of ML algorithms for ML models 210 may be carried out. Once tuned and trained the generated ML models may be evaluated 211 on the test dataset using various metrics (e.g., time to train model and accuracy). An explainable AI algorithm may be run to generate 212 a model explanation for each ML model.

The steps of training, testing, tuning of ML models and generating model explanations may be carried out at the computing system 101 or remotely. For example, at a remote server 104 or using a private cloud 106 or a public cloud 105.

ML model analysis 220 is carried out as part of the workflow 200 by comparing the ML model explanations with domain expert inputs 206. The domain expert inputs 206 may be direct inputs relating to a target subject or may search linked domain expert resources 213.

The workflow 200 enables the user to choose between and prioritize evaluation metrics that are commonly used; for example, predictive accuracy or error rate on unseen data points in the test set and incorporates the evaluation of the significance of the model explanation generated by explainable AI methods. The workflow 200 returns to the user 221 a final score per ML model combining selected metrics. The scores may be used to select a best ML model using a selection strategy and therefore to select a best ML algorithm to use for the target issue.

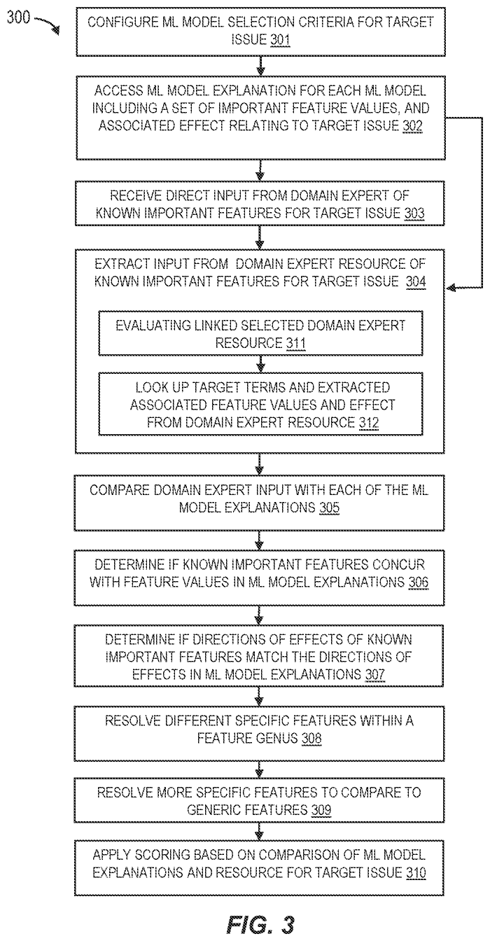

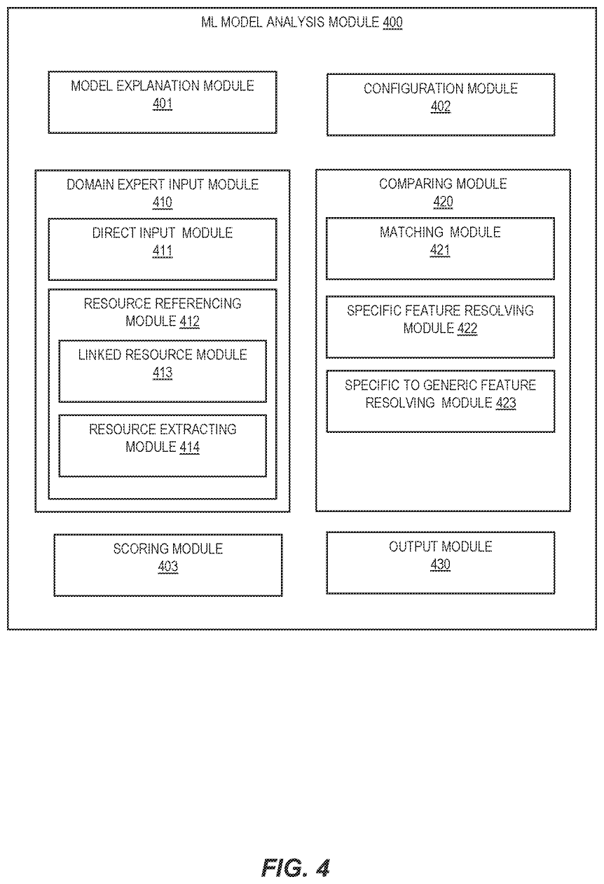

Referring to FIG. 3, a flow diagram 300 shows an example embodiment of the method of analyzing ML models for a target subject. The method may be carried out by a ML model analysis module 400 as shown in FIG. 4.

The method may, in step 301 configure ML model selection criteria and analysis metrics. This may include a number of important features to compare in ML explanations and in domain expert inputs. This may also include weightings for a scoring to be applied to ML models.

The workflow accepts input from the user to define a set of criteria which it can use to compare a variety of predictive ML models that have been fine-tuned and generated to address a specific problem of a target subject.

The method may, in step 302, access a model explanation of each of a plurality of ML models for a target subject. A model explanation may include a set of top n identified important features with feature values and an associated effect of each feature on the target subject. A ML model explanation may use, for example, Shapley Additive Explanations (SHAP) to return feature importance analysis.

In step 303, the method may receive a domain expert input including a set of known important features for the target subject and an associated effect of each feature on the target subject. The associated effect of the features of the ML models and the domain expert input may be positive or negative agreement with the target subject and may have a magnitude. For example, the domain expert input may include positive or misleading features that should or should not appear in the ML model's explanations. Receiving a domain expert input may include receiving a direct input from a domain expert via a user interface and, in step 304, extracting domain expert input from a linked domain expert resource. Extracting 304 the domain expert input may include evaluating one or more linked domain expert resources (as shown in step 311) and/or looking up target terms to extract associated features from the resources for the target subject (as shown in step 312). Domain expert resources may include literature and/or curated biological databases.

In step 305, the method may compare the domain expert input with the plurality of model explanations to evaluate consensus. The comparing may, in step 306, determine a concurrence of at least some of the identified important features of each of the model explanations with at least some of the known important features to determine a consensus between each model explanation and the domain expert input. Determining a concurrence may, as shown in step 307, include determining if there is directional agreement of the effects on the target subject of known important features from the domain expert input with the directions of effects of features in the model explanations.

To assess the ML model explanations, the most influential features from the explanations may automatically be compared to domain expert inputs to identify if associations are already known between the features and the target for prediction. An evaluation of a ML model is therefore based upon the “real world” validity of the ML model explanations. The evaluation may use automated literature searches to identify known feature-target associations from previously published work, databases or inputted documents. Associations are scored based on their strength, wherein higher scoring features that are of higher importance to a model may yield a higher explainability score for the ML model.

In step 308, the method may resolve different specific features within a same genus. This may particularly apply in the context of life sciences. The resolving may use normalized abundance counts from the machine learning model training as input for network construction and analysis of edges in the network to determine significant association between nodes representing specific features. In step 309, the method may resolve more specific features to compare to generic features by accessing additional resources to analyze specific features.

In step 310, the method may apply scoring to the plurality of ML models, including weightings for aspects of the comparison of the domain expert input with the plurality of model explanations. This can be used as an additional criterion for ML model selection. For example, if the user chooses to prioritize ML models with some explanations supported by the literature, referred to as an explainability score. The final scoring may include additional metrics of the machine learning models. A ranking of the ML models may be output based on the final scoring from which ML algorithms may be selected for the target subject.

A final score for a ML model may be computed using a formula that combines different metrics. Each metric may have an associated weight/coefficient that can be tuned by the user based on their preference/prioritization. The weight of a metric may be set to zero if the user does not want to incorporate that specific metric in the final score. A very simple example of formula that consider both accuracy and model explanations to compute the final score for a ML model may be:

Final_score=C1*accuracy+C2*explainability_score, where C1 and C2 are user-defined weights in [0,1].

The described method provides an artificial intelligence workflow that incorporates a domain-knowledge led ML model selection strategy. The user in the form of the domain expert can evaluate and compare ML models based on the significance or validity of explanations of the ML models generated by an explainable AI algorithm. This gives a domain expert the capability to choose the best ML model based on the generated explanation insights (e.g., important features) or conversely to exclude ML models that have features in their explanations which are misleading. The user may incorporate such prioritization of ML models with high explainability scores as well as choosing between and prioritizing evaluation metrics that are commonly used for ML models (e.g., predictive accuracy or error rate).

In healthcare or life sciences, domain expertise provides insight into “important features” in the data (e.g., genetic markers) that may drive ML models predictions. Domain expertise may be, for example, from a clinician or biologist or represented in curated databases or publications. When considering a complex biological system, only part of the story is known, and using innovations such as omic technologies to profile this complexity means that new features are continuously discovered and used to develop ML models. The result of this is that the relative importance of the known “important features” is largely unknown; they will likely be important, but other new features in the data may be more or equally important.

Preference may be given to using ML models that learn or determine the feature importance themselves (e.g., Random Forests), rather than those that incorporate such knowledge as a prior belief (or weighting) that risks adding uncertain assumptions about the data. In this scenario, it is then possible to use explainable AI algorithms to understand the predictions made by ML models and offer insights into which features the ML algorithm consider most important for each prediction. In other words, explainable AI algorithms tell us which features are contributing, positively or negatively, to the predictions of certain target values. Also, adding context and transparency to a prediction enables trustworthiness, which is of high importance in healthcare. Expert users such as clinicians or biologists can see the appearance of their “important features” as a validation of the ML model but can also identify new “important features” that could be used in diagnostics or to advance their understanding of the phenotype being predicted. Such insights, such as the validity of a model's explanations, are not generally considered when choosing between ML methods and models. To date mainly aspects such as the stability or robustness of the explanation are considered. In the described method, it is proposed that, particularly in domains like healthcare and life sciences, the scientific validity of the ML model explanations provide an important criterion for model selection.

The evaluation of the model explanations gives a domain expert the capability to, for example, prioritize ML models whose predictions are driven by some features that they know to be important and correlated with the target or conversely to exclude models that have prioritized some features which they believe to be misleading and not associated with the target.

To evaluate and validate the explanations generated through the explainability algorithm, the workflow computes an explainability score for each hyper-tuned ML algorithm. To compute this score, the workflow may require input of additional information from the domain expert user. This information may include metrics to prioritize when ranking ML models (c.g., accuracy and explainability scores) alongside known insights about the data. For example, known associations/relationships between some features in the data and the phenotype or predicted target.

The user may provide an input list of features that are known to be associated with a specific targeted value or else an automated literature search can be conducted by the AI workflow on relevant databases or documents as specified by the user. An example input may be a list of clinical features (e.g., age, sex, weights, medications, conditions) from a database that are known to affect a better or worse response to treatments for a specific disease, where response to treatment is the target to predict. Another example may be a list of important microbes (of an oral sample) e.g., from the Disbiome® database, whose abundance is known to be associated with an observable trait (higher or lower plaque score) of the host organism (human).

The explainability score may then be computed based on how many of these known important features not only appear in the top X features ranked by the explainability algorithm but also if the association between their feature value and the target value is consistent with domain expert knowledge, expressed by the list of known findings. X is a user-defined threshold, for example top 30. In contrast, the user may also provide a list of features that should not appear in the top Y ranked features by the explainability algorithm, where Y is another user-defined threshold (e.g., 100). This is useful if, for instance, if some features are irrelevant or misleading (e.g., contaminants in microbiome samples) and should not appear in the top Y.

A variety of optimized and trained ML models may be evaluated and ranked based on their computed final score. The final score for a ML model may be computed using a simple or more complicated formula that combines different metrics, for example, accuracy score, explainability score, training time, generalizability score, etc. Each metric has an associated weight or coefficient that can be tuned by the user based on their preference or prioritization. An example is provided using microbiome data. This approach may apply to healthcare tasks using human microbiome samples e.g., from the gut or skin, or broadly across life sciences using environmental microbiome samples e.g., from the soil or ocean.

Inputs may be received including (but not limited to) training and test data, names of desired ML algorithms to tune, train and test, configuration parameters (e.g., HPO type, test set dimension etc., plots to generate etc.), list of metrics to be computed and incorporated in the final score and associated weights as per user-preference. Inputs may also be received of criteria or metrics for prioritization of the ML model selection.

The evaluation ML models may include using direct input from domain expert user. The user may input a list of known “relevant features” or “misleading features” for the target and, optionally, the degree of importance, e.g., how approximately highly ranked in the model explanation they may expect such features to appear. This may be expressed with a threshold X. For example, if predicting skin hydration from skin microbiome data, the user may specify that “Lactobacillus” is expected to appear among the top X(=30) features ranked by the explainability algorithm because “Lactobacillus” is a microbe known to be associated with higher skin hydration.

The evaluation of ML models may include using a literature or resource search. The user may specify terms to search. As we are using data from the microbiome as a specific use case, the examples of search terms may reflect this. The terms include a feature name [e.g., a bacterial species] and a target name [e.g., Crohn's Disease]. The user may specify which literature to search (e.g., private or public databases, such as the public database of Disbiome® database). The user may specify how many of the top features forming the explanation are to be used e.g., top 3.

The ML model selection metrics to choose from may include: accuracy/error, time to run/train model, generalizability, presence/absence of desired features in explanation, ability to validate features in model explanation using literature search or known insights.

The ML models may be trained and tested and an explainable AI algorithm run, for example SHAP, to generate model explanations, which may be at a global and local level.

The ML models may be compared and ranked based on the final score computed by combining the defined metrics as per the user-preference.

In one example, the exemplary explainability criteria may be a literature search via user defined database “Disbiome®” with 67% of features from top 3 of explanation linked to predicted target e.g. “Crohn's Disease”. The exemplary scoring may be: higher % of features higher® explainability score. The method may check if a top 3 bacterial species from a ML model explanation are linked to the target disease under investigation (Crohn's disease) in the selected database (Disbiome®). The method may link to Disbiome® database and “look up” target disease “Crohn's” and extract list of its known associated bacterial species:

TABLE 1
Domain expert feature extraction from literature:

| | Disease | Organism | Effect |
|---|---|---|---|
| 21 | Crohn's Disease | Ruminococcus gnavus | Increased in Crohn's |
| 186 | Crohn's Disease | Lactobacillus | Decreased in Crohn's |
| 427 | Crohn's Disease | Clostridium leptum | Decreased in Crohn's |

The method may check if top 3 bacterial species in output of explainability of ML model 1 in Table 1 are in Table 2, and check if the directions of the effects match the ML phenotype.

TABLE 2
Domain expert feature extraction from literature:

| | Feature value: | |
|---|---|---|
| Feature: bacterial species | Abundance scape 0-1 | Associated Phenotype |
| Ruminococcus gnavus | 1 | Severe Crohn's |
| Clostridium difficile | 0.98 | No Crohn's |
| Lactobacillus acidophilus | 0.05 | Severe Crohn's |

Feature 1 of “Ruminococcus gnavus” can be matched between the domain expert input and the ML model 1 explanation. There is also directional agreement for all features. Feature 2 of “Clostridium difficile” is a different species within the same genus “Clostridium” is associated with Crohn's to resolve the method below may be implemented. The likelihood of interaction between the two species that are compared is determined by automated generation of an interaction network from ML model training data. In microbial ecology, the nodes of a microbial interaction network can represent species and the edges denote functional interactions between them. Normalized microbial abundance counts (from ML model training) may be used as input for the network construction. For example, using software SPIEC-EASI. Edges in a microbial co-occurrence network represent statistically significant association between nodes (here species) allowing the assessment of the statistical likelihood of interaction between two species of interest. If there is a stronger likelihood, a feature has a higher validated score, whereas there is a weaker likelihood, a feature has a lower validated score.

As a complementary check, available DNA genome sequences may be accessed from the species to compare from Ensembl Bacteria. Comparative genomics techniques may be used to assess the degree of similarity (at the sequence and functional level) between species. The higher the similarity, the higher the validated explanation score of our feature (species).

Feature 3 of “Lactobacillus acidophilous” is the genus “Lactobacillus” (not the species) is associated with Crohn's (species is more specific taxonomic group). The method below may be implemented to resolve the ambiguity introduced by only having high (genus) level ground truth experimental evidence for this species. The conserved genetic material or core genome for the genus (e.g. Lactobacillus) is defined. For many genera these do not exist already. DNA genome sequences may be accessed from species in the genus. For example, from Ensembl Bacteria a resource of the European Molecular Biology Laboratory's European Bioinformatics Institute. Orthologous gene cluster groups may be created. The core-genome (genes present in 95-100% of genomes) may be determined, and the core-genome's genes reported. A look up may determine if genes are known to be associated with the disease (e.g. using public database of genes associated with diseases DisGeNET). If Yes, feature has a higher validated score, if No feature has a lower validated score.

In another example, the exemplary criteria may be more extensive. For example:
User expertise: feature×in explanation;
Predictive accuracy or error rate;
Model overfitting/ability to generalize on new independent unseen datasets;
User expertise: feature y in top 20 of the explanation;
Literature search: % of features from top 20 of explanation linked to predicted target e.g. “covid-19”;
User database of known associations: % of features from top 20 of explanation linked to target in database;
Time to train model.

The exemplary scoring may be:
Higher ranked feature→higher explainability score;
Higher accuracy→higher score;
Less overfitting→higher score;
Binary filter: if answer NO reject the model, if answer YES keep model;
Higher % of features→higher explainability score;
Higher % of features→higher explainability score;
Shorter time→higher score.

A further example shows a comparison and scoring of features.

TABLE 3
Domain expert input

| Known Important Feature | Feature Value | Associated phenotype |
|---|---|---|
| Condition | Colitis | Worse drug response |
| Sex | Female | Better drug response |
| Gene A | Expressed | Better drug response |

TABLE 4
Explainability Insights ML Model 1

| Features | Feature Value | Associated phenotype |
|---|---|---|
| 1. Condition | Colitis | Worse drug response |
| 2. Feature Y | y | Worse drug response |
| 3. Sex | Female | Better drug response |
| 4. Feature Z | z | Worse drug response |
| 5. Gene A | Expressed | Better drug response |

ML model 1 has an accuracy score=0.85 and an explainability score=1.0. The explainability score is 1.0 as all the important features of the domain expert input of Table 3 are provided in the explainability insights of Table 4 for the ML model 1. The Weight for the accuracy score, C1=1.0 and the weight for the explainability score, C2=1.0.

The final score for ML model 1 is:

C1*accuracy+C2* explainability score=1*0.85+1*1=1.85

TABLE 5
Explainability Insights ML Model 2

| Features | Feature Value | Associated phenotype |
|---|---|---|
| 1. Feature Y | y | Worse drug response |
| 2. Condition | Colitis | Worse drug response |
| 3. Feature X | x | Better drug response |
| 4. Feature Z | z | Worse drug response |
| 5. Feature Q | q | Better drug response |

ML model 2 has an accuracy score=0.90 and an explainability score=0.33. The explainability score is 0.33 as only one out of three of the important features of the domain expert input of Table 3 is provided in the explainability insights of Table 5 for the ML model 2. The Weight for the accuracy score, C1=0.9 and the weight for the explainability score, C2=1.0.

The final score for ML model 2 is:

C1*accuracy+C2* explainability score=0.9*0.9+1*0.33=1.14.

Therefore, ML model 1 has the best final score.

By validating the ML models' explanations, trust is built in the models' predictions and therefore in the novel insights that they generate. ML algorithms are compared, not only based on the accuracy, but also based on the quality and biological validity of the insights that they generate through explanations. The best machine learning algorithm selected may is the one that maximizes explainability score and accuracy. In the described method, the most influential features from the explainability analysis are automatically compared to literature or expert inputs to identify if feature-target associations are already known. This may be used as an additional criterion to validate ML algorithms and to select the best algorithm. The step to automatically compare features to the literature is non-trivial and it is a main challenge in the life sciences and healthcare domain.

The advantage of incorporating explainable AI algorithms in the method is that not only the explanations (feature-target associations) provide precious insights to the domain experts, but also the models' explanations (feature-target associations) are validated. In the life sciences and healthcare domain it is important to validate the models' explanations because often ML models overfit to the training data. As such, a model could be highly accurate but provide misleading insights.

Explainable AI algorithms tell us which features in the data are contributing, positively or negatively, to the predictions of certain target values. Adding context and transparency to the predictions enables trustworthiness, which is of high importance in healthcare; expert users such as clinicians or biologists can see the appearance of their “important features” as a validation of the ML model but also identify new “important features” that could be used in diagnostics or to advance their understanding of the phenotype being predicted.

Referring to FIG. 4, a block diagram shows an example embodiment of the ML model analysis module 400 depicted in the computing system 101 of FIG. 1, for analyzing machine learning models for a target subject. The ML model analysis module 400 includes modules in the form of software units providing the functionality of the described method. The modules may execute on at least one processor, a hardware module, or a circuit. Multiple processors running parallel processing threads may be provided enabling parallel processing of some or all of the functions of the modules. Memory may be configured to provide computer instructions to the at least one processor to carry out the functionality of the modules.

The ML model analysis module 400 may include a model explanation module 401 for accessing a model explanation of each of a plurality of machine learning models for a target subject. The model explanations may be accessed from a remote source, for example, where they may be generated. A model explanation includes a set of identified important features and an associated effect of each feature on the target subject.

The ML model analysis module 400 may include a configuration module 402 for configuring analysis metrics for the machine learning models.

The ML model analysis module 400 may include a domain expert input module 410 for receiving a domain expert input including a set of known important features for the target subject and an associated effect of each feature on the target subject.

The domain expert input module 410 may include a direct input module 411 for receiving a direct input from a domain expert via a user interface. The domain expert input module 410 may also or alternatively include a resource referencing module 412 which may comprise a linked resource module 413 for evaluating one or more linked domain expert resources and/or a resource extracting module 414 for extracting important features from the resources for the target subject.

The ML model analysis module 400 may include a comparing module 420 for comparing the domain expert input with the plurality of model explanations to evaluate consensus between the features.

The comparing module 420 may comprise a matching module 421 for determining a match of identified important features with known important features including the directional agreement of the features with the target subject. The comparing module 420 may include a specific feature resolving module 422 for resolving different specific features within a same genus including: using normalized abundance counts from the machine learning model training as input for network construction; and analyzing edges in network to determine significant association between nodes representing specific features. In some embodiments, the comparing module 420 may include a specific to generic feature resolving module 423 for resolving more specific features to compare to generic features by accessing additional resources to analyze specific features.

The ML model analysis module 400 can include a scoring module 403 for scoring the plurality of machine learning models, including applying weightings for aspects of the comparison of the domain expert input with the plurality of model explanations.

The ML model analysis module 400 can include an output module 430 for outputting a scoring of the machine learning models with the scoring including the evaluated consensus. The output model 430 may also output a selected ML model and/or ML algorithm according to a selection strategy based on the ML model scoring.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for domain knowledge-based evaluation of machine learning models for a target subject, said computer-implemented method comprising:
accessing a model explanation of each of a plurality of machine learning models for the target subject, wherein a model explanation includes a set of identified important features;
receiving a domain expert input including a set of known important features for the target subject;
comparing the domain expert input with the plurality of model explanations to evaluate consensus based on at least one of the known important features concurring with at least one of the identified important features of the model explanations; and
scoring the machine learning models based on the evaluated consensus.

2. The computer-implemented method of claim 1, wherein the model explanation includes the set of identified important features and an associated effect of each feature on the target subject, and the domain expert input includes the set of known important features and an associated effect of each feature on the target subject, wherein the associated effect of a feature on the target subject includes a directional agreement with the target subject.

3. The computer-implemented method of claim 2, wherein comparing the domain expert input with the plurality of model explanations further comprises:
determining a match of identified important features with known important features including the directional agreement of the features with the target subject.

4. The computer-implemented method of claim 1, wherein receiving a domain expert input comprises:
receiving a direct input from a domain expert via a user interface.

5. The computer-implemented method of claim 1, wherein receiving the domain expert input comprises:
evaluating one or more linked domain expert resources; and
extracting important features from the domain expert resources for the target subject.

6. The computer-implemented method of claim 1, wherein comparing the domain expert input with the plurality of model explanations further comprises:
resolving different specific features within a same genus.

7. The computer-implemented method of claim 6, wherein resolving the different specific features within the same genus further comprises:
using normalized abundance counts from the machine learning model training as input for network construction; and
analyzing edges in a network to determine significant association between nodes representing specific features.

8. The computer-implemented method of claim 1, wherein comparing the domain expert input with the plurality of model explanations further comprises:
resolving one or more specific features to compare to generic features by accessing additional resources to analyze specific features.

9. The computer-implemented method of claim 1, further comprising:
scoring the plurality of machine learning models by applying weightings for aspects of the comparison of the domain expert input with the plurality of model explanations.

10. The computer-implemented method of claim 1, further comprising:
selecting a best machine learning model according to a selection strategy from a ranking of a plurality of machine learning models based on the scoring.

11. A system for analyzing machine learning models for domain knowledge-based evaluation of machine learning models for a target subject, comprising:
a processor and a memory configured to provide computer program instructions to the processor to execute the function of code modules, the program instructions comprising:
accessing a model explanation of each of a plurality of machine learning models for a target subject, wherein a model explanation includes a set of identified important features;
receiving a domain expert input including a set of known important features for the target subject;
comparing the domain expert input with the plurality of model explanations to evaluate consensus based on at least some of the known important features concurring with at least some of the identified important features of the model explanations; and
scoring the machine learning models based on the evaluated consensus.

12. The system of claim 11, wherein the model explanation includes the set of identified important features and an associated effect of each feature on the target subject, and the domain expert input includes the set of known important features and an associated effect of each feature on the target subject, wherein the associated effect of a feature on the target subject includes a directional agreement with the target subject.

13. The system of claim 12, wherein comparing the domain expert input with the plurality of model explanations further comprises:
determining a match of identified important features with known important features including the directional agreement of the features with the target subject.

14. The system of claim 11, wherein receiving a domain expert input comprises:
receiving a direct input from a domain expert via a user interface.

15. The system of claim 11, wherein receiving the domain expert input comprises:
evaluating one or more linked domain expert resources; and
extracting important features from the domain expert resources for the target subject. 16.

16. The system of claim 11, further comprising:
using normalized abundance counts from the machine learning model training as input for network construction; and
analyzing edges in a network to determine significant association between nodes representing specific features.

17. The system of claim 11, wherein comparing the domain expert input with the plurality of model explanations further comprises:
resolving one or more specific features to compare to generic features by accessing additional resources to analyze specific features.

18. The system of claim 11, further comprising:
scoring the plurality of machine learning models by applying weightings for aspects of the comparison of the domain expert input with the plurality of model explanations.

19. The system of claim 11, further comprising:
configuring analysis metrics for the machine learning models.

20. A computer program product for domain knowledge-based evaluation of machine learning models for a target subject, the computer program product comprising a computer readable storage medium having program instructions embodied therewith, the program instructions executable by a processor to cause the processor to:
access a model explanation of each of a plurality of machine learning models for a target subject, wherein a model explanation includes a set of identified important features;
receive a domain expert input including a set of known important features for the target subject;
compare the domain expert input with the plurality of model explanations to evaluate consensus based one at least some of the known important features concurring with at least some of the identified important features of the model explanations; and
score the machine learning models based on the evaluated consensus.
